(19) United States
(12) Patent Application Publication
(10) Pub. No.: US 2023/0340212 A1
(43) Pub. Date: Oct. 26, 2023

(54) METHOD FOR PREPARING AN ENZYME MASTERBATCH

(71) Applicant: CARBIOLICE, (US)

(72) Inventors: Nadia AUCLAIR, Cournon D'auvergne (FR); Chloe GUILLAUMONT, Chambaron sur Morge (FR); Clementine ARNAULT, Clermont Ferrand (FR); Yannick CHARPENTIER, Aigueperse (FR)

(21) Appl. No.: 17/792,272

(22) PCT Filed: Jan. 25, 2021
(86) PCT No.: PCT/EP2021/051546

§ 371 Date: Jul. 12, 2022

(30) Foreign Application Priority Data
Jan. 24, 2020 (FR) FR2000692

(51) Int. Cl. C08J 3/22; C08J 5/18; C08L 67/04

(52) U.S. Cl. CPC C08J 3/226; C08J 5/18; C08L 67/04; C08J 2367/04; C08L 2201/06; C08L 2205/03

(57) ABSTRACT

The invention relates to a method for preparing a masterbatch comprising a polysaccharide, enzymes and a low-melting-point polymer in a mixer. This masterbatch is used, in particular, for the production of biodegradable plastic articles.

### FIELD OF THE INVENTION

The invention relates to a method for preparing a masterbatch comprising a polysaccharide, enzymes and a low-melting-point polymer in a mixer. This masterbatch is used, in particular, for the production of biodegradable plastic articles.

### PRIOR ART

Methods for preparing plastics based on biodegradable and biosourced polyesters have been developed in order to respond to ecological challenges. These plastic products, synthesised from starch or starch derivatives and polyester, are used for manufacturing articles having a short lifespan, such as plastic bags, food packaging, bottles, wrapping films, etc.

These plastic compositions generally contain polyester and flours originating from various cereals (U.S. Pat. Nos. 5,739,244; 6,176,915; US 2004/0167247; WO 2004/113433; FR 2 903 042; FR 2 856 405).

In order to control the degradation of these plastic products, it has been proposed to add one or more additives such as mineral fillers (WO 2010/041063) and/or biological entities having a polyester degrading activity (WO 2013/093355; WO 2016/198652; WO 2016/198650; WO 2016/146540; WO 2016/062695).

Biodegradable plastic articles comprising biological entities, more particularly enzymes dispersed in a polymer, thus have a better biodegradability than plastic products devoid of these enzymes.

Methods for preparing these enzymatic plastics have been previously described, however problems related to homogeneity and roughness may appear and impact on the physical properties of the product. For example, the presence of enzyme aggregates causes a greater roughness, the aesthetics of the product is reduced and the physical and mechanical properties are altered.

A first improvement has been made by providing the enzyme in liquid form to the support polymer (WO 2019/043145, WO 2019/043134).

The present invention describes a method for preparing a masterbatch, which when used in the manufacture of plastic products comprising enzymes dispersed in a polymer, makes it possible to improve the dispersion of the enzymes in the final compound as well as the level of biodegradability of the plastic, without modifying the mechanical properties of the product.

### DISCLOSURE OF THE INVENTION

The present invention relates to a method for preparing a masterbatch comprising a polysaccharide, enzymes and a support polymer in a mixer, said method comprising the following steps:
a) separately introducing enzymes in solution and the polysaccharide and mixing them at a temperature less than the melting temperature of the support polymer;
b) introducing the support polymer into the mixture prepared beforehand in a);
c) mixing the components; and
d) recovering the masterbatch.

The invention also relates to the masterbatches obtained in this way and to plastic articles obtained by mixing the masterbatch with a polymer or a mixture of polymers comprising a polymer capable of being degraded by the enzymes of the masterbatch. It relates, in particular, to a method for preparing an article made of plastic comprising a polymer that is able to be degraded by enzymes and enzymes capable of degrading said polymer, comprising a step of mixing the masterbatch according to the invention with said polymer, alone or in a mixture.

### DETAILED DESCRIPTION OF THE INVENTION

The present invention relates to a method for preparing a masterbatch comprising a polysaccharide, enzymes and a support polymer in a mixer, said method comprising at least the following steps:
a) separately introducing enzymes in solution and the polysaccharide and mixing them at a temperature less than the melting temperature of the support polymer;
b) introducing the support polymer into the mixture prepared beforehand in a);
c) mixing the components; and
d) recovering the masterbatch.

The present invention also relates to a method for preparing a masterbatch comprising a polysaccharide, enzymes and a support polymer in a mixer, said method comprising the following steps: a) introducing separately into a mixer, in particular a twin-screw extruder, the enzymes in solution and a polysaccharide, mixing them at a temperature less than the melting temperature of the support polymer; then b) adding the support polymer to the mixture of enzymes in solution and polysaccharide; and c) mixing them before d) recovering the masterbatch.

Unless otherwise indicated, the percentages are given by weight relative to the total weight of the composition to which they refer.

As it is used here, the term “polysaccharides” refers to molecules composed of long chains of monosaccharide units linked together by glycosidic bonds. The structure of the polysaccharides can be linear to strongly branched. Examples include storage polysaccharides such as starch and glycogen, and structural polysaccharides such as cellulose and chitin. The polysaccharides comprise native polysaccharides or polysaccharides that are chemically modified by cross-linking, oxidation, acetylation, partial hydrolysis, etc.

Carbohydrate polymers can be classified on the basis of their source (marine, plant, microbial or animal), structure (linear, branched) and/or physical behaviour (such as the designation as gum or hydrocolloid, which refers to the property that these polysaccharides hydrate in hot or cold water to form viscous solutions or dispersions, at low concentration of gum or hydrocolloid).

In the context of the invention, the polysaccharides can be classified according to the classification described in “Encapsulation Technologies for Active Food Ingredients and Food Processing—Chapter 3—Materials for Encapsulation—Christine Wandrey, Artur Bartkowiak and Stephen E. Harding”:
Starch and derivatives such as amylose, amylopectin, maltodextrin, glucose syrups, dextrin, and cyclodextrin
Cellulose and derivatives, such as methylcellulose, hydroxypropyl methylcellulose, ethylcellulose, etc.
Plant exudates and extracts, also called vegetable gums or natural gums, including, but not limited to, gum arabic (or gum acacia), gum tragacanth, guar gum, locust bean gum, gum karaya, mesquite gum, galactomannans, pectin, soluble soybean polysaccharide
Marine extracts such as carrageenan and alginate
Microbial and animal polysaccharides such as gellan, dextran, xanthan and chitosan.

The polysaccharides can be classified on the basis of their solubility in water. In particular, cellulose is not soluble in water. According to the invention, the polysaccharides have the ability to be soluble in water

The polysaccharides used in the formulation of plastic compositions are well-known to a person skilled in the art. They are chosen, in particular, from among starch derivatives such as amylose, amylopectin, maltodextrins, glucose syrup, dextrins and cyclodextrins, natural gums such as gum arabic, gum tragacanth, guar gum, locust beam gum, gum karaya, mesquite gum, galactomannans, pectin or soluble soybean polysaccharides, marine extracts such as carrageenans and alginates, and microbial or animal polysaccharides such as gellans, dextrans, xanthans or chitosan, and the mixtures thereof.

The polysaccharide can also be a mixture of several polysaccharides cited above. In a preferred embodiment, the polysaccharide used is a natural gum, and more particularly gum arabic.

The enzymes used are enzymes having a polyester degrading activity or microorganisms producing one or more enzymes having a polyester degrading activity. Their incorporation in products made of biodegradable polyester-based plastic thus improves the biodegradability of the latter.

Examples of enzymes having a polyester degrading activity are well-known to a person skilled in the art, in particular depolymerases, esterases, lipases, cutinases, carboxylesterases, proteases or polyesterases.

Included, in particular, are enzymes capable of degrading polyesters in such a way as to improve the biodegradability of articles prepared with the masterbatch according to the invention. In a particular embodiment of the invention, the enzymes are capable of degrading PLA. Such enzymes and their method of incorporation in thermoplastic articles are known to a person skilled in the art, in particular described in patent applications WO 2013/093355, WO 2016/198652, WO 2016/198650, WO 2016/146540 and WO 2016/062695.

The enzymes used in the context of the invention are chosen, in particular, among proteases and serine proteases. Examples of serine proteases are Proteinase K of Tritirachium album, or PLA-degrading enzymes originating from Amycolatopsis sp., Actinomadura keratinilytica, Laceyella sacchari LP175, Thermus sp., or Bacillus licheniformis or reformulated commercial enzymes known to degrade PLA such as Savinase®, Esperase®, Everlase® or any enzyme of the family of subtilisins CAS [9014-01-1] or any functional variant.

The enzymes can be used in their pure or enriched form, and optionally as a mixture with one or more excipients.

The enzymes are used in the method according to the invention in the form of an enzymatic solution. The solvent is a solvent which does not degrade the enzymes, and more particularly water.

In the context of the invention, the composition of the masterbatch comprises at most 5% enzymes having a polyester degrading activity.

The support polymer is a low-melting-point polymer and a polymer which advantageously has a melting temperature lower than 140° C. and/or a glass transition temperature lower than 70° C. It must also be compatible with the one or more polymers with which the masterbatch will be mixed for preparing the enzymatic plastic articles. Such support polymers are well known to a person skilled in the art. They include, in particular, polycaprolactone (PCL), polybutylene succinate (PBS), polybutylene succinate adipate (PBSA), polybutylene adipate terephthalate (PBAT), polyhdroxyalkanoate (PHA), polylactic acid (PLA) or the copolymers thereof. They can also include natural polymer such as starch or even a polymer that is qualified as universal, in other words compatible with a large range of polymers such as an EVA type copolymer.

Advantageously, the support polymer has a melting temperature lower than 120° C. and/or a glass transition temperature lower than 30° C.

The support polymer is generally a single polymer as defined above. It can also consist of a mixture of these support polymers.

According to a particular embodiment of the invention, the support polymer is PCL. According to another particular embodiment of the invention, the support polymer is PLA.

Step a) corresponds to the addition of the polysaccharide and enzymes into the mixer. The enzymes in solution and the polysaccharide are introduced separately into the mixer. The two components to be mixed can be introduced consecutively, in other words one after the other, or simultaneously. The polysaccharide can be introduced first and then the enzymes in solution, or indeed first the enzymes in solution then the polysaccharide. According to an advantageous embodiment of the invention, the enzymes in solution and the polysaccharide are introduced simultaneously.

The polysaccharide is in powder form and is introduced into the mixer via a metering device specific to powders. The enzymes in aqueous solution are added in liquid form. Their addition is made by any usual means for introducing a solution into a mixer, in particular via a peristaltic pump.

The polysaccharide/enzymes/water mixture comprises, by weight relative to the total weight of the mixture:
0.01% to 35% enzymes,
15% to 95% water, and
3% to 80% polysaccharide.

In an embodiment, the polysaccharide/enzymes/water mixture comprises, by weight relative to the total weight of the mixture:
0.3% to 30% enzymes,
19% to 85% water, and
4% to 80% polysaccharide.

In another embodiment, the polysaccharide/enzymes/water mixture comprises, by weight relative to the total weight of the mixture:
0.3% to 30% enzymes,
19% to 60% water, and
15% to 70% polysaccharide.

The polysaccharide/enzyme solution ratio is determined in such a way as to have a dry mass of at least 35% and at most 55%, even at most 70%.

In an embodiment, the quantity of polysaccharide in the mixture is between 4% and 100% of the maximum solubility of the polysaccharide in water, in other words between 4% and 100% of the saturation concentration of the polysaccharide in water. In other words, the quantity of polysaccharide in the mixture is from 4% to 100% of the maximum solubility of the polysaccharide in the mixture, in other words from 4% to 100% of the saturation concentration of the polysaccharide in the mixture.

The mixing of the compounds, polysaccharide, enzymes and water, is carried out at a temperature lower than the melting temperature of the support polymer.

Advantageously, the temperature is between 25 and 80° C. In a preferred embodiment, the temperature is between 25 and 50° C.

The person skilled in the art would know to adapt the features of the method (temperature and time) necessary for carrying out the step a) on the basis of the components (polysaccharide and enzymes) used.

The mixing in step a) is advantageously carried out for a period less than 30 seconds, more particularly in less than 25 seconds.

Following the mixing of the polysaccharide and the enzyme solution in step a), the low-melting-point polymer is added into the mixer. The support polymer is introduced in a partially or totally molten form. The temperature of the mixer is therefore higher than that of step a). The person skilled in the art would know to adapt the temperature of steps b) and c) of the method in order that the polymer is added in a partially or totally molten form and at a temperature at which the enzymatic activity is conserved.

In general, the temperature of steps b) and c) is between 40 and 200° C. The temperature is preferably between 55 and 175° C. In a preferred embodiment, the temperature of steps b) and c) is adjusted according to the nature of the polymer used.

Typically, the temperature does not exceed 300° C., more particularly, the temperature does not exceed 250° C.

It is sought to maintain a temperature of the mixture in step c) which is the lowest allowing a mixing and homogeneous dispersion of enzymes and of the polysaccharide in the support polymer.

The mixing of the polysaccharide, enzyme and support polymer components in step c), is carried out for a period of 10 to 30 seconds. In a preferred embodiment, the mixing lasts between 15 and 25 seconds, more preferably 20 seconds.

In the course of the process for producing the masterbatch, the temperature is gradually increased in order to ensure a homogeneous and constant mixing while preserving the characteristics and properties of each of the components as much as possible.

Advantageously, the residence time of the polysaccharide/enzymes composition in the polymer at a temperature above 100° C. within the mixer (steps b) and c)) is as short as possible. It is preferably between 5 seconds and 10 minutes. However a residence time less than 5 minutes is preferred. In a preferred embodiment, this is less than 3 minutes, and optionally less than 2 minutes.

The masterbatch obtained in step d) is in solid form. It is advantageously recovered in the form of granules. These granules can be stored, transported and incorporated in the manufacture of products or articles made of plastic, whatever their shape and their use, which may be called “end products”. It may involve films, or flexible or solid parts with shapes and volumes suitable for their uses.

The formulation of the masterbatch may comprise a mineral filler. In this case, the mineral compound is introduced during step a), after the addition of the polysaccharide and the enzyme solution into the mixer.

A plurality of minerals can be used. Examples are calcite, carbonate salts or metal carbonates such as calcium carbonate, potassium carbonate, magnesium carbonate, aluminium carbonate, zinc carbonate, copper carbonate, chalk, dolomite; silicate salts, such as calcium silicate, potassium silicate, magnesium silicate, aluminium silicate, or a mixture thereof, such as micas, smectites such as montmorillonite, vermiculite, and sepiolite-palygorskite; sulfate salts, such as barium sulfate or calcium sulfate (gypsum), mica; hydroxide salts or metal hydroxides such as calcium hydroxide, potassium hydroxide (potash), magnesium hydroxide, aluminium hydroxide, sodium hydroxide (caustic soda), hydrotalcite; metal oxides or oxides salts such as magnesium oxide, calcium oxide, aluminium oxide, iron oxide, copper oxide, clay, asbestos, silica, graphite, carbon black; metal fibres or metal petals; glass fibres; magnetic fibres; ceramic fibres and derivatives and/or mixtures thereof.

In a preferred embodiment, the mineral filler used is calcium carbonate.

In general, the masterbatch is formulated with:
50 to 90% support polymer,
5 to 30% enzyme solution
2 to 20% polysaccharide, and
0 to 20% mineral filler.

The masterbatch may also comprise the presence of one or more compounds. In particular, the masterbatch may comprise one or more additives. In general, the additives are used in order to improve the specific properties of the end product. For example, the additives can be chosen from plasticisers, colouring agents, processing aids, rheological agents, antistatic agents, anti-UV agents, reinforcement agents, compatibility agents, flame retardants, antioxidants, pro-oxidants, light stabilisers, oxygen scavengers, adhesives, products, excipients, etc.

Advantageously, the masterbatch comprises less than 20% by weight of additives and preferably less than 10% relative to the total weight of the masterbatch. In general, the composition of the masterbatch comprises 0% to 10% by weight of additives relative to the total weight of the masterbatch.

The composition of the masterbatch after formulation comprises between 5% and 30% by weight enzyme solution, relative to the total weight of the masterbatch into which the enzymes have been introduced in aqueous solution and the composition of which is defined above.

In an embodiment, the enzyme solution represents between 8% and 22% by weight relative to the total weight of the composition.

In a preferred embodiment, the masterbatch comprises between 10% and 20% enzyme solution by weight of its composition.

In any event, the enzymes are chosen for being capable of degrading at least one polymer of the plastic article which will be obtained by the use of the masterbatch in its method of manufacture.

In an embodiment, the composition of the masterbatch after formulation comprises, relative to the total weight of the composition: 50% to 95% by weight polyester, 5% to 50% by weight enzyme solution and polysaccharide, 0 to 20% by weight mineral filler and, optionally, at least one additive.

In another preferred embodiment, the composition of the masterbatch after formulation comprises, relative to the total weight of the composition: 60% to 90% by weight polyester, 10% to 30% by weight enzyme solution and polysaccharide, 0 to 10% by weight mineral filler and, optionally, at least one additive.

The method of manufacture of the masterbatch is performed in a mixer. The person skilled in the art knows various types of mixers that can be used for the manufacture of these polymer masterbatches.

In a preferred embodiment, the mixer is an extruder. This can be of the single-screw or twin-screw type. It is preferably of the twin-screw type.

In particular, the method is implemented in an extruder comprising at least four zones, a head zone where the first components are introduced at a first temperature, an intermediate zone where other components are added at a second temperature, a mixing zone and an outlet zone via which the masterbatch is recovered, with the following steps a) to d):
a) separately introducing a polysaccharide and an enzyme solution in the head zone, and mixing thereof at a temperature less than the melting temperature of the low-melting-point polymer;
b) introducing a support polymer in the intermediate zone;
c) mixing the components in the mixing zone;
d) recovering the masterbatch at the extruder outlet.

The support polymer is introduced in the partially or totally molten state in step b) by means of an extruder or lateral feeder.

The person skilled in the art will know to adapt the features of the extruder (i.e. the length and diameter of the one or more screws, the degassing zones, etc.) and the residence time of the polysaccharide, enzymes and low-melting-point polymer on the basis of time and temperature constraints of different steps of the method of the invention.

The masterbatch can be obtained in the form of granules prepared according to the usual techniques. These granules can be stored, transported and used in the manufacture of biodegradable plastic articles that can be called “end articles”.

When it is in the form of granules, the masterbatch can be dried for storage thereof. The drying methods are the usual methods known to the person skilled in the art, in particular with the use of hot air ovens, vacuum ovens, desiccators, microwaves or fluidised beds. The drying temperature and duration will depend on the water content contributed by the enzyme solution in the preparation of the masterbatch, but also on the melting and glass transition temperatures of the support polymer used.

Once dry, the composition of the masterbatch advantageously comprises:
55% to 95% support polymer,
0.5% to 7% enzyme,
2% to 27% polysaccharide, and
0% to 30% mineral filler.

The moisture content is generally 0.5% or less and preferably less than 0.3%.

The masterbatch obtained in the form of granules can then enter into the manufacture of biodegradable plastic products or “end articles”. It may involve films, or flexible or solid parts with shapes and volumes suitable for their uses.

The biodegradable plastic article is obtained by mixing the masterbatch comprising the enzymes with at least one polymer that is able to be degraded by said enzymes.

The invention therefore relates to a method for preparing an article made of plastic or a pre-mixture as defined above comprising a polymer that is able to be degraded by enzymes and enzymes capable of degrading said polymer, said method comprising the steps of preparing a masterbatch comprising enzymes capable of degrading said polymer, a polysaccharide, and a support polymer, the masterbatch being prepared in a mixer by a method comprising the following steps:
a) separately introducing, into the mixer, enzymes in solution and the polysaccharide, and mixing them at a temperature less than the melting temperature of the support polymer;
b) introducing the support polymer into the mixture prepared beforehand in a);
c) mixing the components; and
d) recovering the masterbatch, then mixing said polymer that is able to be degraded by enzymes with the masterbatch.

Advantageously, said polymer that is able to be degraded by the enzymes is a biodegradable polyester. These polyesters are well known to the person skilled in the art, such as polylactic acid (PLA), polyglycolic acid (PGA), polyhydroxyalkanoate (PHA), polycaprolactone (PCL), polybutylene succinate (PBS), polybutylene succinate adipate (PBSA), polybutylene adipate terephthalate (PBAT), plasticised starch and the mixtures thereof.

These polyesters are chosen for their physicochemical properties on the basis of the end article and properties which are sought, in particular its mechanical properties but also their colour and transparency.

The biodegradable polyesters used for the preparation of end articles have physicochemical properties that are identical or different from the polyesters used as support polymers in the masterbatch according to the invention.

In a preferred embodiment, the polyester that can be degraded by the enzymes comprises PLA, alone or in mixture with another polyester above, in particular a PLA/PBAT mixture.

The biodegradable plastic article thus consists of the masterbatch and a biodegradable polymer.

The composition of the biodegradable plastic article comprises, in addition to the biodegradable polymer, 0.5% to 20% of enzyme masterbatch.

The methods for preparing these end articles are well-known to the person skilled in the art, comprising in particular the usual plastic technology techniques such as inflation extrusion, extrusion blow moulding, cast film extrusion, calendering and thermoforming, injection moulding, compression moulding, rotational moulding, coating, stratification, expansion, pultrusion and compression-granulation. Such operations are well-known to the person skilled in the art, who will easily adapt the conditions of the method according to the type of plastic articles envisaged (for example temperature, residence time, etc.).

For the preparation of biodegradable plastic articles, the masterbatch can be mixed with the other constituents of the composition for the shaping thereof. It is also possible to prepare a pre-mixture or “compound” comprising the masterbatch and at least the biodegradable polymer. This pre-mixture in solid form, in particular in the form of granules, can be stored and then transported before being used to shape the end article, alone or in combination with other constituents, according to the end composition of the end article.

Advantageously, the pre-mixture comprises:
8% to 99% by weight biodegradable polymer, preferably PLA,
0.01% to 5% by weight of a polysaccharide, preferably a natural gum such as gum arabic,
0.1% to 20% by weight of a support polymer, as defined above, in particular PCL, and
0.01% to 2% by weight enzymes having a degrading activity for biodegradable polymer, more particularly having a degrading activity of PLA, and where appropriate
0 to 35% by weight mineral filler.

The end articles can be films, flexible or solid parts with shapes and volumes suitable for their uses. Examples of biodegradable plastic articles concerned by the invention are films, mulching films, wrapping films, food or non-food films; packaging such as packaging blisters, trays; disposable tableware such as cups, plates or cutlery; stoppers and lids; beverage capsules; and horticultural articles.

Advantageously, the composition of the plastic article is the following:
60% to 98% by weight polymer or biodegradable polymer mixtures,
0.01% to 5% by weight of a polysaccharide, preferably a natural gum such as gum arabic,
0.01% to 20% by weight of a support polymer, as defined above,
0.01% to 2% by weight enzymes having a degrading activity for biodegradable polymer,
0% to 35% by weight mineral filler,
0% to 5% by weight additives.

The biodegradable plastic articles obtained with the enzyme masterbatch can be flexible and/or rigid.

In the case of flexible articles, the polyester that can be degraded by enzymes comprises PLA. In an embodiment; the biodegradable polyester is a PBAT/PLA mixture, the weight ratio of which preferably ranges from 10/90 to 20/80, more preferably from 13/87 to 15/85.

In another embodiment, the biodegradable polyester is a PBAT/PLA mixture, the weight ratio of which ranges from 10/90 to 30/70, from 10/90 to 40/60, from 10/90 to 50/50, from 10/90 to 60/40, from 10/90 to 70/30, from 10/90 to 80/20, from 10/90 to 90/10.

In another embodiment, the biodegradable polyester is a PBAT/PLA mixture, the weight ratio of which is less than 10/90, less than or equal to 9/91, less than equal to 8/92, less than equal to 7/93, less than equal to 6/94, less than equal to 5/95, less than equal to 4/96, less than equal to 3/97, less than equal to 2/98, less than equal to 1/99.

In another embodiment, the biodegradable polyester is PLA.

The flexible biodegradable plastic articles are characterised by a thickness less 250 μm, preferably by a thickness less than 200 μm. In a preferred embodiment, the films have a thickness less than 100 μm, more advantageously less than 50 μm, 40 μm or 30 μm, preferably between 10 and 20 μm. More preferably, the thickness of the flexible article is 15 μm. Examples are films, such as food films, wrapping films, industrial films or mulching films and bags.

Advantageously, the composition of the flexible article comprises:
70% to 98% by weight polymer or biodegradable polymer mixture,
0.01% to 5% by weight of a polysaccharide, preferably a natural gum such as gum arabic,
0.1% to 20% by weight of a support polymer, as defined above, and
0.01% to 2% by weight enzymes having a degrading activity for biodegradable polymer,
0% to 5% by weight mineral filler, in particular 0.01% to 5% by weight, in particular 0.05 to 5% by weight,
0% to 5% by weight additives.

The composition according to the invention is particularly suitable for producing plastic films. The films according to the invention can be produced according to the usual technical methods, in particular by inflation extrusion. The films can be prepared from granules of composition according to the invention, which are melted according to the usual techniques, in particular by extrusion.

The films of composition as previously defined with enzymes can be single-layer or multilayer films. In the case of a multilayer film, at least one of the layers is of composition as previously defined. The single-layer and multilayer films, of composition as previously defined, have a high PLA content and retain mechanical properties as sought for the preparation of biodegradable and biosourced films, in particular for packaging food and non-food products. To this effect, the constituents of the composition according to the invention will be preferably chosen from products compatible with food use.

The multilayer film can be a film comprising at least 3 layers, of type ABA, ABCA or ACBCA, the layers A, B and C being of different compositions. In a preferred embodiment, the multilayer films are of type ABA or ACBCA.

In general, the layers A and B comprise PLA and/or a polyester, advantageously a composition according to the invention. The layers C, if present, are there in order to contribute particular properties to the articles according to the invention, more particularly to contribute barrier properties to gas and in particular to oxygen. Such barrier materials are well known to the person skilled in the art, and in particular PVOH (polyvinyl alcohol), PVCD (polyvinyl chloride), PGA (polyglycolic acid), cellulose and its derivatives, milk proteins or polysaccharides and the mixtures thereof in all proportions.

In the case of multilayer films as defined above, and in particular for films of type ABA, ABCA or ACBCA, the enzymes can be present in all the layers or even in only one of the layers, for example in layers A and B or only in layer A or in layer B.

According to a particular embodiment of the invention, the two A layers are formed of a composition according to the invention comprising PLA, polyester and polypropylene glycol diglycidyl ether (PPGDGE), without enzymes. The enzymes are in layer B, either in a composition according to the invention with enzymes as defined above, or in a particular composition, in particular an enzyme composition in a low-melting-point polymer defined above.

According to the embodiments, the composition of the enzymatic layer of (single-layer or multilayer) flexible articles can comprise up to 95% by weight biodegradable polymer, preferably PLA. Hence, the enzymatic layer can comprise 8% to 50%, 8% to 60%, 8% to 70%, 8% to 80% or even 8% to 90% by weight biodegradable polymer.

Advantageously, the composition of the enzymatic layer of (single-layer or multilayer) flexible articles comprises:
8% to 95% by weight biodegradable polymer, preferably PLA, in particular 8% to 70%, 8% to 60%, 8% to 50%, or 8% to 40%,
0.02% to 4% by weight of a polysaccharide, preferably a natural gum such as gum arabic,
0.1% to 19% by weight of a support polymer, as defined above, and
0.05% to 2% by weight enzymes having a degrading activity for biodegradable polymer, more particularly having a degrading activity of PLA, and where appropriate
0% to 5% by weight mineral filler, in particular 0.01% to 5% by weight, in particular 0.05 to 5% by weight,

With regard to the rigid articles, the biodegradable polyester is PLA, preferably a PLA/calcium carbonate mixture The weight ratio ranges from 100/0 to 25/75, preferably from 95/5 to 45/55, more preferably from 90/10 to 50/50. In another embodiment; the biodegradable polyester is a PBAT/PLA mixture, the weight ratio of which preferably ranges from 10/90 to 80/20, more preferably from 20/80 to 60/40.

The rigid articles have a thickness between 200 μm and 5 mm, between 150 μm and 5 mm, preferably between 200 m and 3 mm, or between 150 μm and 3 mm. In an embodiment, the articles have a thickness between 200 μm and 1 mm, between 150 μm and 1 mm, preferably between 200 μm and 750 μm or between 150 μm and 750 μm. In another embodiment, the thickness is 450 μm.

Examples of such biodegradable plastic articles are cups, plates, cutlery, trays, drink capsules and packaging blisters, more generally packaging for food, cosmetics or horticultural products.

Advantageously, the composition of the rigid article comprises:
60% to 95% by weight polymer or biodegradable polymer mixture,
0.01% to 5% by weight of a polysaccharide, preferably a natural gum such as gum arabic,
0.1% to 20% by weight of a support polymer, as defined above,
0.01% to 2% by weight enzymes having a degrading activity for biodegradable polymer,
0% to 35% by weight mineral filler, in particular 0.01 to 35% by weight,
0% to 5% by weight additives.

In another embodiment, the composition of the rigid article comprises:
60% to 80% by weight biodegradable polymer or polymer mixture,
0.01% to 5% by weight of a polysaccharide, preferably a natural gum such as gum arabic,
0.1% to 20% by weight of a support polymer, as defined above, and
0.01% to 2% by weight enzymes having a degrading activity for biodegradable polymer,
8% to 35% by weight mineral filler,
0% to 5% by weight additives.

The composition of the rigid article thus comprises more than 60% by weight biodegradable polymer or mixture of polymers, or even more than 70%, or even more than 80%, or even more than 90%.

The mineral filler content in the rigid article is between 0.01% and 35% by weight according to the nature of the mineral filler.

According to some embodiments, the rigid article thus comprises more than 0.01%, more than 0.1%, more than 1%, or even more than 2%, or even more than 3% by weight mineral filler.

In other embodiments, the quantity by weight of mineral filler is greater than or equal to 4%, greater than or equal to 5%, greater than or equal to 6%, greater than or equal to 7%, or greater than or equal to 8%.

In yet other embodiments, the mineral filler comprised in the rigid article is 10 to 35% by weight, 15% to 30%, or 20% to 28% by weight.

Whether flexible or rigid, the end articles can also comprise plasticisers, compatibilisers and other common additives entering into the composition of plastics, such as pigments or dyes, release agents, impact modifiers, anti-blocking agents, etc.

Examples of plasticisers are citrate esters and lactic acid oligomers (LAO).

Citrate esters are plasticisers known to the person skilled in the art, in particular as biosourced materials. They include, in particular, triethyl citrate (TEC), the triethyl acetyl citrate (TEAC), tributyl citrate (TBC) and tributyl acetyl citrate (TBAC). Preferably, the citrate ester used as plasticiser in the composition according to the invention is TBAC. LAOs are also plasticisers known to the person skilled in the art, in particular as biosourced materials. They include lactic acid oligomers of molecular weight less than 1500 g/mol. They are preferably esters of lactic acid oligomers, their carboxylic acid termination being blocked by esterification with an alcohol, in particular a C1-C10 linear or branched alcohol, advantageously a C6-C10 alcohol, or a mixture of the latter. LAOs described in patent application EP 2 256 149 could be cited with their method of preparation, and the LAOs marketed by Condensia Quimica under the tradename Glyplast®, in particular the references Glyplast® OLA 2, which has a molecular weight of 500 to 600 g/mol and Glyplast® OLA 8 which has a molecular weight of 1000 to 1100 g/mol. According to a preferred embodiment of the invention, the LAOs have a molecular weight of at least 900 g/mol, preferably 1000 to 1400 g/mol, more preferably 1000 to 1100 g/mol.

Poly(propylene glycol) diglycidyl ethers, also called glycidyl ethers, described in particular as “reactive plasticisers” in patent application WO 2013/104743, are used for the preparation of block copolymers with PLA and PBAT. They are also identified as liquid epoxy resin, from DOW, marketed under reference “D.E.R.™ 732P”, or again as aliphatic epoxy resin from HEXION, marketed under reference “Epikote™ Resin 877”.

The composition according to the invention can optionally comprise other PLA/polyester compatibilisers associated with PPGDGE. Such PLA/polyester compatibilisers are well known to the person skilled in the art, in particular chosen from polyacrylates, ethylene terpolymers, acrylic ester and glycidyl methacrylate (marketed, for example, under the tradename Lotader@ by Arkema), triblock copolymers PLA-PBAT-PLA, PLA grafted with maleic anhydride (PLA-g-AM) or PBAT grafted with maleic anhydride (PBAT-g-AM), in particular poly(ethylene-co-methyl acrylate-co-glycidyl methacrylate) described, in particular, by Dong & al. (International Journal of Molecular Sciences, 2013, 14, 20189-20203) and Ojijo & al. (Polymer 2015, 80, 1-17), more particularly marketed under the name JONCRYL® by BASF, preferably grade ADR 4468.

The invention also relates to a method for preparing an article made of plastic or a pre-mixture as defined above comprising a polymer that is able to be degraded by enzymes and enzymes capable of degrading said polymer, said method comprising the steps of preparing a masterbatch comprising enzymes capable of degrading said polymer, a polysaccharide and a support polymer, the masterbatch being prepared in a mixer by a method comprising the following steps:
a) separately introducing, into the mixer, enzymes in solution and the polysaccharide, and mixing them at a temperature less than the melting temperature of the support polymer;
b) introducing the support polymer into the mixture prepared beforehand in a); c) mixing the components; and
d) recovering the masterbatch,
then mixing said polymer that is able to be degraded by enzymes with the masterbatch.

### EXAMPLES

### Example 1: Masterbatch Preparation

1. Commercial Products

In these examples, PCL marketed under reference Capa™ 6500 by Perstorp, calcium carbonate marketed under reference OMYAFILM 707-OG by Omya, and gum arabic marketed under reference InstantGumAA by Nexira have been used

II. Preparation of a Support Polymer and Enzymes Mixture
1. Masterbatch preparation under prior art conditions

Mixture A1 of support polymer and enzymes is prepared from granules of polycaprolactone (PCL) and enzymes in liquid form.

The mixture of support polymer and enzymes has been manufactured with a twin-screw extruder CLEXTRAL EV25HT comprising 11 zones for which the temperature is independently monitored and controlled. The PCL is introduced in zone 1 at 16 kg/h and the enzyme solution in zone 5 at 4 kg/h using a peristaltic pump. The zones are heated according to Table 1. 20% of the enzymatic solution containing the polysaccharide is introduced into the PCL (% by weight relative to the total weight).

TABLE 1
Temperature profile (° C.) used for mixing support polymer and enzymes

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 40 | 65 | 75 | 75 | 60 | 60 | 60 | 60 | 60 | 60 | 60 |

The mixture A2 of support polymer and enzymes was prepared in the same way as for the mixture of support polymer and enzymes A1. Only calcium carbonate has been added to the preparation. PCL and the enzymatic solution were introduced, under the same conditions as for mixture A1 at 12 kg/h and 6 kg/h respectively The calcium carbonate was introduced simultaneously with the PCL in zone 1 at 2 kg/h. The extrusion temperatures used are identical to those used for the preparation of the polymers/enzymes mixture A1.
2. Preparation of a Masterbatch According to the Method of the Invention

The mixture B of support polymer and enzymes is prepared from granules of polycaprolactone (PCL), a polysaccharide (gum arabic) and enzymes in solution, according to the method of the invention.

The mixture of support polymer and enzymes was manufactured with a co-rotating twin-screw extruder Clextral Evolum 25 HT comprising 11 zones for which the temperature is independently monitored and controlled. The enzymes in solution and the gum arabic were introduced simultaneously at the start of the extruder in order to produce a mixture according to a rising temperature profile between 25 and 50° C. The enzymes in solution are introduced at 2.2 kg/h using a peristaltic pump. Gum arabic is itself introduced at 1.8 kg/h using a metering device specifically for powders. PCL, also referred to as support polymer, is introduced at 16 kg/h in a partially or even totally molten state between zone 5 and zone 6 of the extruder at an actual temperature of 55° C.

The mixture C of support polymer and enzymes of the invention was prepared in the same way as for the mixture of support polymer and enzymes B. The enzymes in solution are introduced at 2.4 kg/h using a peristaltic pump. The gum arabic itself is introduced at 1.6 kg/h using a metering device specifically for powders. PCL, also referred to as support polymer, is introduced at 16 kg/h in a partially or even totally molten state between zone 5 and zone 6 of the extruder.

Mixture D of support polymer and enzymes of the invention is similar to mixture C; only calcium carbonate has been added to the preparation. In order to do this, a dry-blend has been prepared with the gum arabic. The addition is therefore made at the start of the extruder via a powder metering device simultaneously with the solution, at a rate of 3.6 kg/h. The PCL itself is introduced at 14 kg/h.

### Example 2: Use of the Masterbatch in Flexible Articles

1. Commercial Products

In these examples, PLA marketed under reference Ingeo™ Biopolymer 4043D by NatureWorks, PLA-PBAT marketed under reference Ecovio® F2223 by BASF, of the Joncryl® ADR 4468 marketed by BASF, TBAC Citrofol® BII marketed by Jungbunzlauer and the PBAT marketed under reference A400 by Wango, have been used.

II. Preparation of PBAT and PLA Mixture Granules

The granules were produced on a twin-screw co-rotative Clextral Evolum 25 HT. Two gravimetric metering devices were used to introduce the polymers (PLA and PBAT) and the compatibiliser and a PCM pump was used for metering the liquid TBAC.

The PLA and Joncryl® mixture was introduced via a metering device at the start of the screw, in the presence of the plasticiser TBAC. The mixture was molten and fed into the introduction zone of the PBAT, which itself arrived in the partially or totally molten state.

The granules were prepared at a screw speed of 450 rpm and a flow rate of 40 kg/h.

The parameters used for the extrusion of granules are given in Table 2.

TABLE 2
Temperature profile (° C.) used for the extrusion of granules

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 50 | 195 | 195 | 195 | 195 | 195 | 200 | 200 | 200 | 200 | 200 |

The mixture of components arrives in the molten state in the screw in Z11 and is immediately granulated with an underwater cutting system to obtain half-moon shaped granules of diameter less than 3 mm.

A prior art composition is prepared comprising 35% PLA and 61% PBAT, 2.5% TBAC and 0.4% Joncryl® ADR 4468 C (% by weight relative to the total weight of the composition).

III. Production of Films
1. Single-Layer Films

The films were prepared using the granules prepared in example 2.11 or the granules of Ecovio F2223, and the support polymer and enzyme mixtures A1-A2-B-C-D prepared in example 1. II.1 and II.2.

The compositions of these different films are listed in Table 3.

TABLE 3
Summary of single-layer films produced

| | | Overall enzyme |
|---|---|---|
| Reference | Composition | content (%) |
| Film 1 | Granules ex. 2.II | 0% |
| (e = 15 μm) | | |
| Film 2 | Granules Ecovio F2223 | 0% |
| (e = 15 μm) | | |
| Film 3 | Granules ex. 2.II + | <0.1% |
| (e = 15 μm) | Mixture A1 ex. 1.II.1 | |
| Film 4 | Granules ex. 2.II + | <than % enzymes |
| (e = 15 μm) | Mixture B ex. 1.II.2 | in the film 3 |
| Film 5 | Granules ex. 2.II + | >0.1% |
| (e = 15 μm) | Mixture C ex. 1.II.2 | |
| Film 6 | Granules ex. 2.II + | Identical to film 5 |
| (e = 15 μm) | Mixture D ex. 1.II.2 | |
| Film 7 | Granules ex. 2.II + | >than % enzymes |
| (e = 15 μm) | Mixture A2 ex. 1.II.1 | of films 5 and 6 |
| Film 8 | Granules Ecovio F2223 + | Identical to film 5 |
| (e = 15 μm) | Mixture D ex. 1.II.2 | |
| Film 9 | Granules Ecovio F2223 + | Identical to film 5 |
| (e = 50 μm) | Mixture D ex. 1.II.2 | |

A laboratory line Labtech LF-250, screw of 30 L/D type LBE20-30/C was used for the inflation extrusion. The screw speed is 50 rpm, the high and low drawing speeds are between 1.9 and 6.1 m/min.

The inflation extrusion temperatures are detailed in Table 4.

TABLE 4
Inflation extrusion temperatures for films 1, 5, 6 and 7

| Zone | Z1 | Z2 | Z3 | Z4 | Die #1 | Die #2 |
|---|---|---|---|---|---|---|
| Temperature (° C.) | 160 | 165 | 165 | 160 | 160 | 160 |

Inflation extrusion temperatures for film 2

| Zone | Z1 | Z2 | Z3 | Z4 | Die #1 | Die #2 |
|---|---|---|---|---|---|---|
| Temperature (° C.) | 160 | 160 | 160 | 160 | 150 | 155 |

Inflation extrusion temperatures for films 3 and 4

| Zone | Z1 | Z2 | Z3 | Z4 | Die #1 | Die #2 |
|---|---|---|---|---|---|---|
| Temperature (° C.) | 160 | 160 | 160 | 160 | 160 | 160 |

Inflation extrusion temperatures for film 8

| Zone | Z1 | Z2 | Z3 | Z4 | Die #1 | Die #2 |
|---|---|---|---|---|---|---|
| Temperature (° C.) | 130 | 160 | 160 | 160 | 150 | 155 |

Inflation extrusion temperatures for film 9

| Zone | Z1 | Z2 | Z3 | Z4 | Die #1 | Die #2 |
|---|---|---|---|---|---|---|
| Temperature (° C.) | 160 | 165 | 165 | 160 | 165 | 165 |

2. Three-Layer Films

The films were prepared using the granules prepared in example 2.11 or granules of Ecovio F2223, and the support polymer and enzymes mixture D prepared in example 1.II.2.

The compositions of these different films are listed in Table 5.

TABLE 5
Summary of the three-layer films produced

| | | Overall enzyme |
|---|---|---|
| Reference | Composition | content (%) |
| Film 10 | Layers A-B-C: Granules | 0% |
| (e = 15 μm) | ex. 2.II | |
| Film 11 | Layers A-B-C: Granules | 0% |
| (e = 15 μm) | Ecovio F2223 | |
| Film 12 | Layers A-C: Granules | >0.1% |
| (e = 15 μm) | Ecovio F2223 | |
| | Layer B: Granules | |
| | Ecovio F2223 + | |
| | Mixture D ex. 1.II.2 | |
| Film 13 | Layers A-C: Granules | >0.1% |
| (e = 30 μm) | Ecovio F2223 | |
| | Layer B: Granules | |
| | Ecovio F2223 + | |
| | Mixture D ex. 1.II.2 | |

A laboratory EUR.EX.MA of type K3A, screw diameterA and C: xtr20 and B: xtr25 was used for the three-layer inflation extrusion. The screw speeds are 20 to 30 rpm pour for screws A and C and 40 to 45 rpm for screw B, the drawings speed is between 5 and 11 m/min.

The inflation extrusion temperatures are detailed in Tables 6.

TABLE 6

| | | | | | | | |
|---|---|---|---|---|---|---|---|
| Zone | Z1 | Z2 | Z3 | Sheath | Die #1 | Die #2 | Die #3 |

a: Inflation extrusion temperatures for film 10

| | | | | |
|---|---|---|---|---|
| Temperature (° C.) - | 155 | 183 | 178 | 178 |
| screw A | | | | |
| Temperature (° C.) - | 173 | | | |
| screw B | | | | |
| Temperature (° C.) - | 171 | | | |
| screw C | | | | |

b: Inflation extrusion temperatures for film 12

| | | | | |
|---|---|---|---|---|
| Temperature (° C.) - | 140 | 161 | 156 | 156 |
| screw A | | | | |
| Temperature (° C.) - | 155 | | | |
| screw B | | | | |
| Temperature (° C.) - | 152 | | | |
| screw C | | | | |

c: Inflation extrusion temperatures for film 13

| | | | | |
|---|---|---|---|---|
| Temperature (° C.) - | 153 | 175 | 175 | 165 |
| screw A | | | | |
| Temperature (° C.) - | 172 | | | |
| screw B | | | | |
| Temperature (° C.) - | 164 | | | |
| screw C | | | | |

### IV. Analysis Method

The tensile and tear mechanical properties can be measured using a Zwick or Llyod type machine, equipped with a 50 N sensor or a 5 kN sensor. The properties are measured in two different directions: in the longitudinal direction and in the transverse direction. The tensile and tear mechanical properties are measured according to standards EN ISO 527-3 and ISO 6383-1 respectively.

With regard to the perforation strength, this is measured using a Dart-Test according to standard NF EN ISO 7765-1.

The opacity of films is characterised by the measurement of the cloudiness (Haze) according to standard ASTM D1003-07 (11/2007), procedure B—Haze measurement with a spectrocolorimeter.

The evaluation of the biodegradability of films has been evaluated using a depolymerisation test carried out according to the following protocol: 100 mg of each sample was introduced into a plastic vial containing 50 mL of buffer solution at pH 9.5. The depolymerisation is launched by incubating each sample at 45° C. in an incubator stirred at 150 rpm. A 1-ml aliquot of buffer solution is regularly sampled and filtered using a 0.22 μm filter syringe in order to be analysed by high performance liquid chromatography (HPLC) using an Aminex column HPX-87H for measuring the release of lactic acid (LA) and its dimer. The chromatography system used is an Ultimate 3000 UHPLC system (Thermo Fisher Scientific, Inc. Waltham, MA, USA) comprising a pump, an automatic sampler, a column thermostated at 50° C. and a detector of 220 nm UV. The eluent is 5 mM H₂SO₄. The injection is 20 μL of sample. The lactic acid is measured on the basis of standard curves prepared from commercial lactic acid.

The hydrolysis of the plastic films is calculated on the basis of the lactic acid and of the lactic acid dimer released. The percentage of depolymerisation is calculated with regard to the percentage of PLA in the sample.

V. Analysis Results
1. Single-Layer Films
a. Control films

Depolymerisation of the PLA of Films 1 and 2

Films 1 and 2 composed of two different polymer matrices and containing no enzyme having a depolymerisation rate less than a 1% after five days at 45° C., and less than 1% and 0% after two days at 28° C. These results testify to the zero-depolymerisation of the polymer matrices alone.
b. Films Containing Different Masterbatches (3-4-5-6-7)

Granule Density by Pycnometry

The masterbatch A1 originating from the preparation method described in paragraph ex 2.II.1 has a density equivalent to that of the masterbatch B originating from the preparation method of the invention described in paragraph ex 2.II.2, namely 1.16 g/cm³.

The preparation method of the support polymer and enzymes mixture has no impact on the density of the final compound.

Thermogravimetric Analyses

The thermogravimetric analyses carried out on these two mixtures prepared in paragraph II show that all the components of the formulation are at equivalent decomposition temperatures. A difference is observed in terms of quantity, since the masses recovered above 450° C. differ slightly according to the method used. The results are presented in Table 7.

TABLE 7
Thermogravimetric analysis results

| Decomposition | Mixture A1 | Mixture B |
|---|---|---|
| temperature | ex 2.II.1 | ex 2.II.2 |
| ~295° C. | ~7.5% | ~7.7% |
| ~390° C. | ~87% | ~86.2% |
| ~450° C. | ~3.8% | ~2.1% |
| ~450-800° C. | ~1.5% | ~4% |
| Residues | ~0.2% | ~0% |

The interactions between the gum arabic and the enzymatic solution are therefore different according to the method of preparation of these two masterbatches.

Mechanical Properties of Films 3 and 4

The mechanical properties measured on the film from the prior art and that from the invention are presented in Table 8. The values indicated represent the average of all the measurements performed.

TABLE 8
Characterisation of the mechanical properties of the films

| Film | | 1 | 2 |
|---|---|---|---|
| Film density (g/cm3) film | | 1.23 | 1.23 |
| Thickness (μm) | | 16 | 16 |
| | Measurement | | |
| Properties | direction | | |
| Strain at | LD | 100% | +17% |
| break (%) | TD | 100% | +28% |
| Elongation at | LD | 100% | +25% |
| break (%) | TD | 100% | +45% |
| Young's | LD | 100% | +0% |
| Modulus (%) | TD | 100% | +0% |
| Tear | LD | 100% | +1% |
| strength (%) | TD | 100% | +0% |
| Dart Test (%) | / | 100% | +36% |

(with LD = Longitudinal direction of the film and TD = transverse direction of the film)
The mechanical properties thus measured show that the film described in the invention has mechanical properties maintained or even greater than that of the film of the prior art.

Haze Measurements on Films 3-4 and on Films 5-6

Three values of Haze have been measured; the average is indicated in Table 9.

TABLE 9
Characterisation of the transparency of films

| | Film 3 | Standard | Film 4 | Standard |
|---|---|---|---|---|
| | e = 16 μm | deviation | e = 16 μm | deviation |
| Haze value | 95.385% | 0.097 | 95.714% | 0.172 |
| (%) | | | | |

The method of preparation of the support polymer and enzyme mixture has no impact on the transparency or opacity of the end product.

The comparison of films 5 and 6 make it possible to evaluate the impact of the mineral filler present in the support polymer and enzymes mixture.

Three values of Haze have been measured, the average is indicated in Table 10.

TABLE 10
Characterisation of the transparency of films

| | Film 5 | Standard | Film 6 | Standard |
|---|---|---|---|---|
| | e = 16 μm | deviation | e = 16 μm | deviation |
| Haze value | 95.850% | 0.211 | 96.170% | 0.188 |
| (%) | | | | |

The addition of a calcium carbonate mineral filler has no impact on the transparency or opacity of the end product.

Depolymerisation of the PLA of Films 5, 6 and 7

Films 5 and 6 containing the same content of enzymes have a depolymerisation range of 16% and 25% respectively, after two days at 45° C. The addition of calcium carbonate in the composition of the support polymer and enzyme mixture promotes the depolymerisation of PLA.

Film 6 containing a support polymer and enzymes mixture manufactured according to the method described in the invention and film 7 containing a support polymer and enzymes mixture manufactured under conventional conditions have a depolymerisation rate of 25% after two days at 45° C. The enzyme content in film 6 is less than that of film 7, the method of preparing the mixture described in the invention make it possible to obtain a depolymerisation rate identical to the conventional method but with less enzymes.
c. Films with 5% Masterbatch

Depolymerisation of the PLA of Films 6 and 8

Films 6 and 8 composed of two different polymer matrices and containing an approximately similar enzyme content have a depolymerisation rate of 25% and 53% respectively after two days at 45° C., and of 21% and 44% after 20 days at 28° C. In other words, the PLA of film 8 reacts more efficiently with the masterbatch than that of film 6.
d. Films with Different Thicknesses

Depolymerisation of the PLA of Films 8 and 9

Films 8 and 9 with different thicknesses (15 and 30 μm) have a depolymerisation rate of 53% and 22% respectively after two days at 45° C., and of 44% and 7% after 20 days at 28° C. The thickness of the film influences the depolymerisation of PLA. For a given masterbatch, when the thickness increases, the depolymerisation rate reduces.

### Example 3: Use of the Masterbatch in Rigid Articles

I. Commercial Products

In these examples, PLA marketed under reference PLA marketed under reference LX175 by Total Corbion, calcium carbonate marketed under reference Filler PL 776 by Plastikakritis have been used

II. Production of Calendered Sheets and of Injected Test Specimens
1. Calendered Sheets

The sheets were prepared using the granules of PLA LX175 and the support polymer and enzymes mixture D prepared in example 1.II.2.

The compositions of these different calendered sheets are listed in Table 11.

TABLE 11
Summary of the calendered sheets produced

| | | Overall enzyme |
|---|---|---|
| Reference | Composition | content (%) |
| Sheet 1 | Granules LX175 + | >0.1% |
| (e = 450 μm) | Mixture D ex. 1.II.2 | |
| Sheet 2 | Granules LX175 + | >0.1% |
| (e = 450 μm) | Mixture D ex. 1.II.2 | |
| Sheet 3 | Granules LX175 + | >0.1% |
| (e = 450 μm) | Mixture D ex. 1.II.2 + | |
| | CaCO3 Filler PL 776 | |
| Sheet 4 | Granules LX175 + | >0.1% |
| (e = 30 μm) | Mixture D ex. 1.II.2 | |

A laboratory line Labtech, single-screw Yvroud was used for the calendering exclusion. For the sheets of thickness 450 μm, the screw speed is between 40 and 55.8 rpm and the drawing speeds are generally between 1.2 and 1.4 m/min. For the sheet of thickness 30 μm, the screw speed is 13 rpm and the drawing speed is generally 8 m/min.

The calendering extrusion temperatures are detailed in Table 2.

TABLE 42a
Calendering extrusion temperatures for sheet 1

| Zone | Z1 | Z2 | Z3 | Die #1 | Die #2 | Die #3 | Die #4 |
|---|---|---|---|---|---|---|---|
| Temperature (° C.) | 175 | 175 | 175 | 175 | 175 | 175 | 170 |

TABLE 52b
Calendering extrusion temperatures for sheets 2 and 4

| Zone | Z1 | Z2 | Z3 | Die #1 | Die #2 | Die #3 | Die #4 |
|---|---|---|---|---|---|---|---|
| Temperature (° C.) | 160 | 160 | 160 | 170 | 170 | 170 | 165 |

TABLE 62c
Calendering extrusion temperatures for sheet 3

| Zone | Z1 | Z2 | Z3 | Die #1 | Die #2 | Die #3 | Die #4 |
|---|---|---|---|---|---|---|---|
| Temperature (° C.) | 170 | 170 | 170 | 170 | 170 | 170 | 165 |

2. Injected Plates

The test specimens were prepared using the granules of PLA LX175 and the support polymer and enzyme mixture D prepared in example 1.II.2.

The compositions of these different test specimens are listed in Table 73.

TABLE 73
Summary of test specimens produced

| | | Overall enzyme |
|---|---|---|
| Reference | Composition | content (%) |
| Plate 1 | Granules LX175 | 0% |
| (e = 2 mm) | | |
| Plate 2 | Granules LX175 + | >0.1% |
| (e = 2 m) | Mixture D ex. 1.II.2 | |

A laboratory line KM 50t/380 CX ClassiX 50T was used for the injection. The injections is 82 mm/s, and the injection pressure is 1271 bars.

The injection temperatures are detailed in Tables 14.

TABLE 14
Injection temperatures for plate 1

| Zone | Z feed | Z1 | Z2 | Z3 | Z4 | Z5 |
|---|---|---|---|---|---|---|
| Temperature (° C.) | 45 | 165 | 165 | 165 | 165 | 165 |

Injection temperatures for plate 2

| Zone | Z feed | Z1 | Z2 | Z3 | Z4 | Z5 |
|---|---|---|---|---|---|---|
| Temperature (° C.) | 45 | 165 | 165 | 165 | 165 | 165 |

III. Analysis Method

The analysis of the degrading of calendered sheets by depolymerisation is carried out in the same way as in paragraph example 2.IV, with the exception of the preparation of the sample which is carried out by micronisation.

IV. Analysis Results
1. Calendered Sheets
   a. Control

Depolymerisation of the PLA of Sheet 1

Sheet 1 does not contain any enzymes but only the PLA LX175 and PCL polymer matrix as control masterbatch. It has a depolymerisation rate less than 1% after five days at 45° C., and after 20 days at 28° C. The results of this analysis being approximately zero, this enables the control to be certified.
b. Sheet with and without addition of CaCO₃

Depolymerisation of the PLA of Sheets 2 and 3

Sheets 2 and 3 have a similar composition with the exception of the addition of a masterbatch filled with CaCO₃ for sheet 3. The two sheets have almost the same enzyme content and have a depolymerisation rate of 19% and 73% respectively after two days at 45° C., and of 5% and 24% after 20 days at 28° C. The nature of the PLA matrix of sheet 2 reacts more in the presence of a masterbatch containing CaCO₃.
c. Sheets of Different Thicknesses

Depolymerisation of the PLA of Sheets 2 and 4

Sheets 2 and 4 of different thickness (450 and 30 μm) have a depolymerisation rate of 19% and 62% respectively after two days at 45° C., and of 5% and 55% after 20 days at 28° C. The increase in thickness of the film has a negative impact on the depolymerisation of PLA.
2. Injected Test Specimens
   a. Control

Depolymerisation of the PLA of Plate 1

Plate 1 contains only PLA LX175 and has a depolymerisation rate less than 1% after two days at 45° C., and of 0.11% after 20 days at 28° C. The results of this analysis being approximately zero, the control is verified.
b. Plate with 5% Masterbatch

Depolymerisation of the PLA of Plate 2

Plate 2 has a depolymerisation rate of 26% after two days at 45° C., and 8% after 20 days at 28° C. The results of this analysis show the action of the masterbatch on the PLA matrix in a plate.

1. Method for preparing a masterbatch comprising a polysaccharide, enzymes and a support polymer in a mixer, wherein the method comprises the following steps:
a) separately introducing enzymes in solution and the polysaccharide and mixing them at a temperature less than the melting temperature of the support polymer;
b) introducing the support polymer;
c) mixing the components; and
d) recovering the masterbatch.

2. The method according to claim 1, wherein the enzymes in solution and the polysaccharide are introduced into the mixer simultaneously.

3. The method according to claim 1, wherein the polysaccharide is starch derivatives, natural gums, soluble soybean polysaccharides, marine extracts and microbial and animal polysaccharides, or the mixtures thereof in any proportions.

4. The method according to claim 1, wherein the polysaccharide is gum arabic.

5. The method according to claim 1, wherein the enzymes are added in the form of an aqueous solution.

6. The method according to claim 1, wherein the polysaccharide/enzymes/water mixture comprises, by weight relative to the total weight of the mixture:
0.01% to 35% enzymes,
15% to 95% water, and
3% to 80% polysaccharide.

7.-8. (canceled)

9. The method according to claim 1, wherein the temperature of step a) is between 25° C. and 80° C.

10. (canceled)

11. The method according to claim 1, wherein the mixing of the polysaccharide and the enzymatic solution in step a) is carried out in less than 30 seconds.

12. (canceled)

13. The method according to claim 1, wherein the support polymer is introduced in step b) in the partially or totally molten state.

14. The method according to claim 1, wherein the support polymer is chosen from polycaprolactone (PCL), polybutylene succinate adipate (PBSA), polybutylene adipate terephthalate (PBAT), polydioxanone (PDS), polyhydroxyalkanoate (PHA) and polylactic acid (PLA) and the mixtures thereof.

15. The method according to claim 1, wherein the support is polymer polycaprolactone (PCL).

16. The method according to claim 1, wherein the mixing in step c) is carried out for between 10 and 30 seconds.

17.-18. (canceled)

19. The method according to claim 1, further comprising adding a mineral filler in step a).

20. The method according to claim 19, wherein the mineral is calcium carbonate.

21. The method according to claim 1, wherein the mixer is an extruder.

22. The method according to claim 21, wherein the extruder comprises at least four zones, a head zone where the first components are introduced at a first temperature, an intermediate zone where other components are added at a second temperature, a mixing zone and an outlet zone via which the masterbatch is recovered, with the following steps a) to d):
a) separately introducing a polysaccharide and an enzymatic solution in the head zone, and mixing thereof at a temperature less than the melting temperature of the low-melting-point polymer;
b) introducing a support polymer in the intermediate zone;
c) mixing the components in the mixing zone; and
d) recovering the masterbatch at the extruder outlet.

23. The method according to claim 1, wherein the masterbatch is obtained in step d) in the form of granules.

24. The method according to claim 1, wherein the formulation contains:
50 to 90% low-melting-point polymer,
5 to 30% enzymatic solution,
2 to 20% polysaccharide, and
0 to 20% mineral filler.

25. (canceled)

26. Method for preparing a plastic article or a pre-mixture comprising a polymer that is able to be degraded by enzymes and enzymes capable of degrading said polymer, characterised in that it comprises a step of mixing the polymer with the masterbatch obtained according to claim 1, the enzymes of the masterbatch being capable of degrading said polymer of the plastic article or of the pre-mixture.

27. The method according to claim 26, wherein the polymer that is able to be degraded by enzymes of the plastic article or of the pre-mixture is polylactic acid (PLA).
